(19) United States
(12) Patent Application Publication
(10) Pub. No.: US 2026/0036425 A1
(43) Pub. Date: Feb. 5, 2026

(54) ANGLE CALCULATING SYSTEM AND METHOD THEREOF

(71) Applicants: KUO-CHIH TSAI, Taoyuan City (TW); CHUN-PIN PAN, Hsinchu County (TW)

(72) Inventors: KUO-CHIH TSAI, Taoyuan City (TW); CHUN-PIN PAN, Hsinchu County (TW)

(21) Appl. No.: 17/908,138

(22) PCT Filed: Apr. 29, 2021
(86) PCT No.: PCT/CN2021/090873

§ 371 Date: Mar. 7, 2024

(51) Int. Cl. G01C 9/02; G01C 25/00; G01P 15/18; G01P 21/00

(52) U.S. Cl. CPC G01C 9/02; G01C 25/00; G01P 15/18; G01P 21/00

(57) ABSTRACT

This invention discloses an angle calculation system and a method thereof. The angle calculation system includes a target point device, a reference point device and a terminal device. The target point device and the reference point device measure the inertia of the target point and the inertia of the reference point respectively so as to obtain a target point data and a reference point data. Then, the terminal device converts the target point data and the reference point data into a horizontal angle and a rotational angle. Afterward, the terminal device calculates the relative horizontal angle and the relative rotational angle between the target point and the reference point in order to measure the horizontal angle and the rotational angle between two points away from each other.

### BACKGROUND OF THE INVENTION

### 1. Field of the Invention

The present invention relates to a measurement technology, in particular to a measurement device, based on inertia, for measuring horizontal angel and rotational angle.

### 2. Description of the Prior Art

In different engineering fields, engineers always need to focus on the measurements of horizontal angels and rotational angles when they manufacture products or build houses so as to avoid that the finished products or houses cannot work normally due to errors caused by manufacturing processes or building processes. Thus, engineers often use bubble levels or laser levels to measure the horizontal level between two points.

However, both of the bubble level and the laser level can only measure the horizontal error between the finished product or the building and the ground. Besides, the engineer can only determine the measurement result by human eyes, which tends to incur errors. Further, the two types of levels cannot be applied to the case not based on the ground serving as the horizontal reference plane.

Moreover, neither the bubble level nor the laser level can be applied to a building if the two ends of the building, such as a bridge, are away from each other by several hundred meters. In order to solve the above problem, theodolites and total stations are developed. However, theodolites and total stations are large and expensive. In addition, the theodolites and total stations can only be operated by professional technicians. Thus, it has become an important issue to provide a light and simple device capable of precisely measure the horizontal error of a large building.

The inventor of the present invention has tried hard to improve currently available devices in order to improve the shortcomings of prior art. After conducting research and experiments for many years, the inventor of the present invention successfully develops an angle calculation system and the method thereof.

### SUMMARY OF THE INVENTION

In order to solve the above problems of prior art, the present invention provides an angle calculation system and the method thereof, and the objectives of the present invention are as follows:
1. Provide a level meter for measuring the horizontal level between two points away from each other.
2. Provide a light rotational angle meter easy to operate.
3. Provide a meter with real-time monitoring function for measuring horizontal angle and rotational angle.

One embodiment of the present invention provides an angle calculation system includes a target point device, a reference point device and a terminal device. The target point device and the reference point device measure the inertia of the target point and the inertia of the reference point respectively so as to obtain a target point data and a reference point data. Next, the target point data and the reference point data are transmitted to the terminal device. The terminal device includes a receiving unit, a processing module and a display module. The processing module further includes an inclination angle converting unit, a horizontal angle converting unit, a relative horizontal angle calculating unit, a rotational angle converting unit and a relative rotational angle calculation unit.

In one embodiment, the inclination angle calculating unit converts the target point data into a target point inclination angle and converts the reference point data into a reference point inclination angle according to the acceleration calculation equation for inclined plane and the standard gravity.

The acceleration calculation equation for inclined plane is as follows:

$${θ}_{a x i s} = {sin}^{- 1} ( \frac{{A}_{a x i s}}{{g}_{0}} )$$

In this equation, g₀ stands for the standard gravity; θₐₓᵢₛ stands for the target point inclination angle or the reference point inclination angle in each of the axial directions; Aₐₓᵢₛ stands for the target point acceleration or the reference point acceleration in each of the axial directions.

In one embodiment, the horizontal angle converting unit converts the reference point inclination angle into a reference point horizontal angle according to the geometric relation of the reference point inclination angle being equal to the reference point horizontal angle in the horizontal axial direction. Similarly, the horizontal angle converting unit converts the target point inclination angle into a target point horizontal angle according to the geometric relation of the target point inclination angle being equal to the target point horizontal angle in the horizontal axial direction.

Finally, the relative horizontal angle calculating unit substrates the reference point horizontal angle from the target point horizontal angle so as to obtain a relative horizontal angle.

In one embodiment, the rotational angle converting unit converts the reference point inclination angle into a reference point rotational angle according to the relation of the reference point inclination angle being equal to the reference point rotational angle. Similarly, the rotational angle converting unit converts the target point inclination angle into a target point rotational angle according to the relation of the target point inclination angle being equal to the target point rotational angle.

Finally, the relative rotational angle calculating unit substrates the reference point rotational angle from the target point rotational angle in order obtain a relative rotational angle.

In one embodiment, the target point device and the reference point device are accelerometers or gyroscopes or the combination thereof.

In one embodiment, the target point data and the reference point data are acceleration data.

In one embodiment, the central communication device is a wireless access point.

In one embodiment, the central communication device may be omitted. The terminal device can be directly connected to the target point device and the reference point device via the receiving unit.

To sum up, the present invention integrates the target point device, the reference point device and the processing device with each other with a view to obtain the target point horizontal angle, the reference point horizontal angle, the target point rotational angle and the reference point rotational angle. Thus, the relative horizontal angle and the relative rotational angle between the target point and the reference point can be calculated accordingly.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1 is the schematic view of an angle calculation system in accordance with the present invention.

FIG. 2 is the schematic view of a target point device in accordance with the present invention.

FIG. 3 is the flow chart of a relative horizontal angle calculation method in accordance with the present invention.

FIG. 4 is the schematic view of rotating the target point device in accordance with the present invention.

FIG. 5 is the schematic view of rotating the target point device in multiple axes in accordance with the present invention.

FIG. 6 is the flow chart of a relative rotational angle calculation method in accordance with the present invention.

FIG. 7 is the schematic view of a first embodiment of the present invention.

FIG. 8 is the schematic view of a second embodiment of the present invention.

FIG. 9 is the schematic view of a display module in accordance with the present invention.

### DETAILED DESCRIPTION OF THE PREFERRED EMBODIMENT

The following description is about embodiments of the present invention; however it is not intended to limit the scope of the present invention.

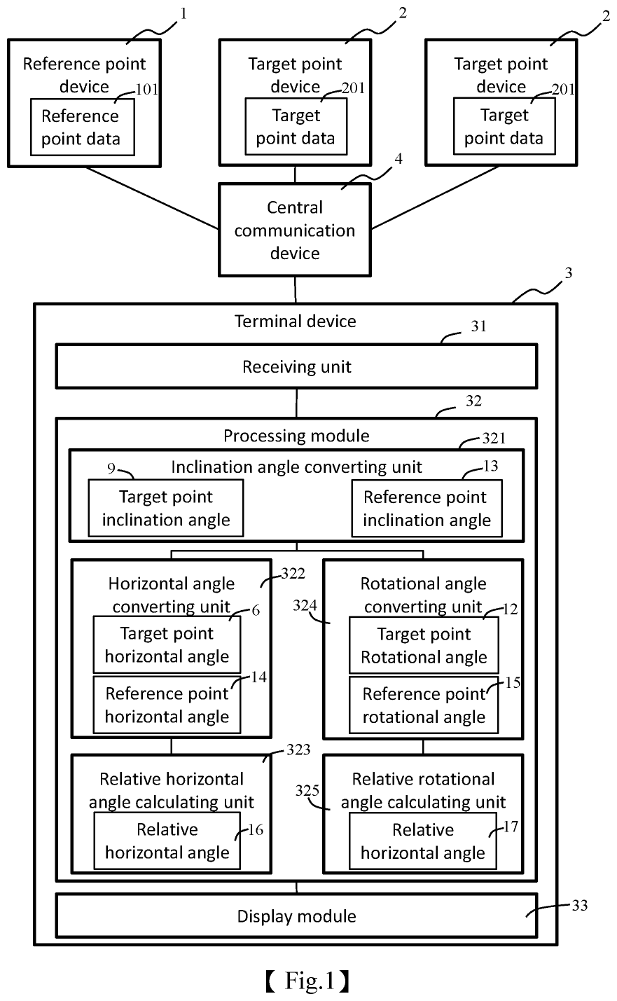

Please refer to FIG. 1, which is the schematic view of an angle calculation system in accordance with the present invention. As shown in FIG. 1, the angle calculation system according to the present invention includes a reference point data 1, target point devices 2, a terminal device 4 and a central communication device 4. In this embodiment, there is only one reference point device 1 while there are two target point devices 2. The reference point device 1 and the target point devices 2 are connected to the terminal device 3 via the central communication device 3.

The reference point device 1 detects the inertia of the reference point to obtain a reference point data 101 and transmits the reference point data 101 to the terminal device 3.

Each of the target point devices 2 detects the inertia of each of the target points to obtain a target point data 201 and transmits the target point data 201 to the terminal device 3.

The terminal device 3 includes a receiving unit 31, a processing module 32 and a display module 33. The processing module 32 further includes an inclination angle converting unit 321, a horizontal angle converting unit 322, a relative horizontal angle calculating unit 323, a rotational angle converting unit 324 and a relative rotational angle calculating unit 325.

When the reference point device 1 and the target point devices 2 transmit the reference point data 101 and the target point data 201 to the terminal device 3 via the central communication device 4, the receiving unit 31 receives the reference point data 101 and the target point data 201. Afterward, the receiving unit 31 transmits the reference point data 101 and the target point data 201 to the processing module 32. Then, the processing module 32 obtains the target point inclination angle 9 and the reference point inclination angle 13 via the inclination angle converting unit 321.

When the user wants to obtain the relative horizontal angle 16 between the any one of the target points and the reference point, the horizontal angle converting unit 322 converts the target point inclination angle 9 into a target point horizontal angle 6 and converts the reference point inclination angle 13 into a reference point horizontal angle 14. Then, the relative horizontal angle calculating unit 323 substrates the reference point horizontal angle 14 from the target point horizontal angle 6 in order to obtain the relative horizontal angle 16 between the target point and the reference point.

When the user wants to obtain the relative rotational angle 17 between the any one of the target points and the reference point, the rotational angle converting unit 324 converts the target point inclination angle 9 into a target point rotational angle 12 and converts the reference point inclination angle 13 into a reference point rotational angle 15. Then, the relative rotational angle calculating unit 325 substrates the reference point reference point rotational angle 15 from the target point rotational angle 12 in order to obtain the relative rotational angle 17 between the target point and the reference point.

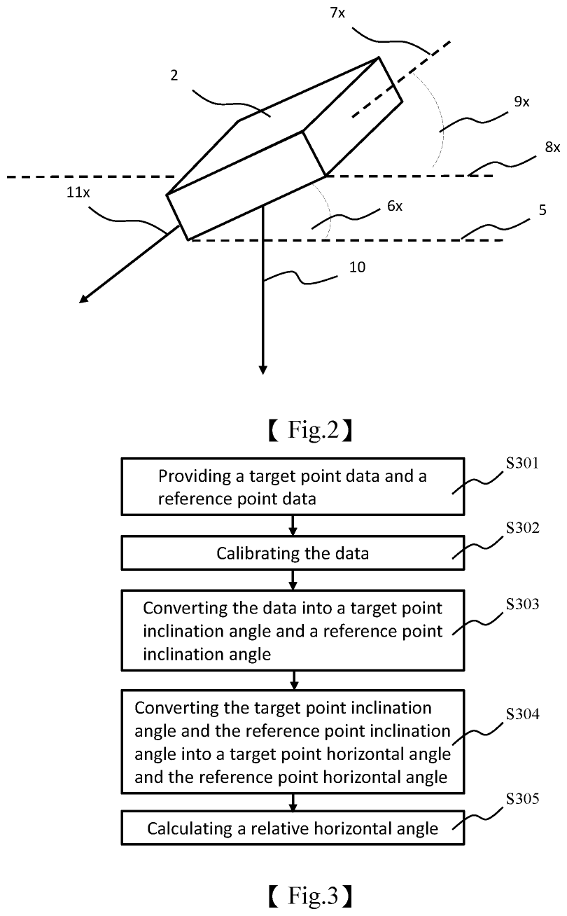

Please refer to FIG. 2, which is the schematic view of a target point device in accordance with the present invention. As shown in FIG. 2, when the target point device 2 inclines, there is an x-axis target point horizontal angle 6x, in x-axis direction 7x, formed between the target point device 2 and the horizontal plane 5. Besides, there is an x-axis target point inclination angle 9x, in x-axis direction 7x, between the x-axis direction 7x and the original x-axis direction 8x. Meanwhile, the target point device 2 can measure an x-axis target point acceleration 11x in the x-axis direction 7x of the target point device 2.

In this embodiment, the inclination converting unit 321 can obtain the x-axis target point inclination angle 9x in the x-axis direction 7x according to the acceleration calculation equation for inclined plane. The acceleration calculation equation for inclined plane can be expressed as the equation given below:

$${θ}_{a x i s} = {sin}^{- 1} ( \frac{{A}_{a x i s}}{{g}_{0}} ) ;$$

In this embodiment of the present invention, g₀ stands for the standard gravity 10; θₐₓᵢₛ stands for the target point inclination angle 9 in each axis direction 7; Aₐₓᵢₛ stands for the target point acceleration 11 in each axial direction 7.

The horizontal angle converting unit 322 can estimate that the x-axis target point inclination angle 9x is equal to the x-axis target point horizontal angle 6x according to the relation of the original x-axis direction 8x being parallel to the horizonal plane 5 with a view to further obtain the x-axis target point horizontal angle 6x.

Please refer to FIG. 3, which is the flow chart of a relative horizontal angle calculation method in accordance with the present invention. The relative horizontal angle calculation method of the present invention starts from Step S301. This step is to provide a reference point data 101 and a target point data 201. The target point data 201 are provided by the target point devices 2, which may include the accelerations, of each of the target points, in x-axis, y-axis and z-axis. The corresponding reference point data 101 are provided by the reference point device 1, which may include the accelerations, of the reference point, in x-axis, y-axis and z-axis.

In Step S302, the method of the present invention applies a calibration operator to the reference point data 101 and the target point data 201 so as to eliminate the mechanical errors of the reference point device 1 and the target point devices 2.

In this embodiment, the calibration operator is a matrix. If the vector (Aₓ, A_{y}, A_{z}) stands for the target point data 101 or the reference point data 201 measured in the horizontal plane, Ô stands for the calibration operator and (0, 0, g₀) stands for the standard gravity, the equation Ô(Aₓ, A_{y}, A_{z})=(0, 0, g₀) can be obtained.

In Step S303, the method of the present invention converts the target point data 201 into the target point inclination angle 9 via the acceleration calculation equation for inclined plane. Similarly, the method of the present invention converts the reference point data 101 into the reference point inclination angle 13 via the acceleration calculation equation for inclined plane. The acceleration calculation equation for inclined plane can be expressed as the equation given below:

$${θ}_{a x i s} = {sin}^{- 1} ( \frac{{A}_{a x i s}}{{g}_{0}} ) ;$$

In the above equation, g₀ stands for the standard gravity; θₐₓᵢₛ stands for the target point inclination angle 9 or reference point inclination angle in each axis direction 7; Aₐₓᵢₛ stands for the target point acceleration 11 or reference point acceleration in each axial direction 7.

In Step S304, the method of the present invention can estimate that the target point inclination angle 9 is equal to the target point horizontal angle 6 in each axial direction 7, and the reference point inclination angle is equal to the reference point horizontal angle in each axial direction 7 according to the geometric relation. Thus, the target point horizontal angle 6 and the reference point horizontal angle in each axial direction 7 can be obtained.

The reference point inclination angle 13 and the reference point horizontal angle can be obtained by the same way of obtaining the target point inclination angle 9 and the target point horizontal angle 6, so will not be described herein again.

In Step S305, the method of the present invention can substrate the reference point horizontal angle from the target point horizontal angle in order to obtain a relative inclination angle.

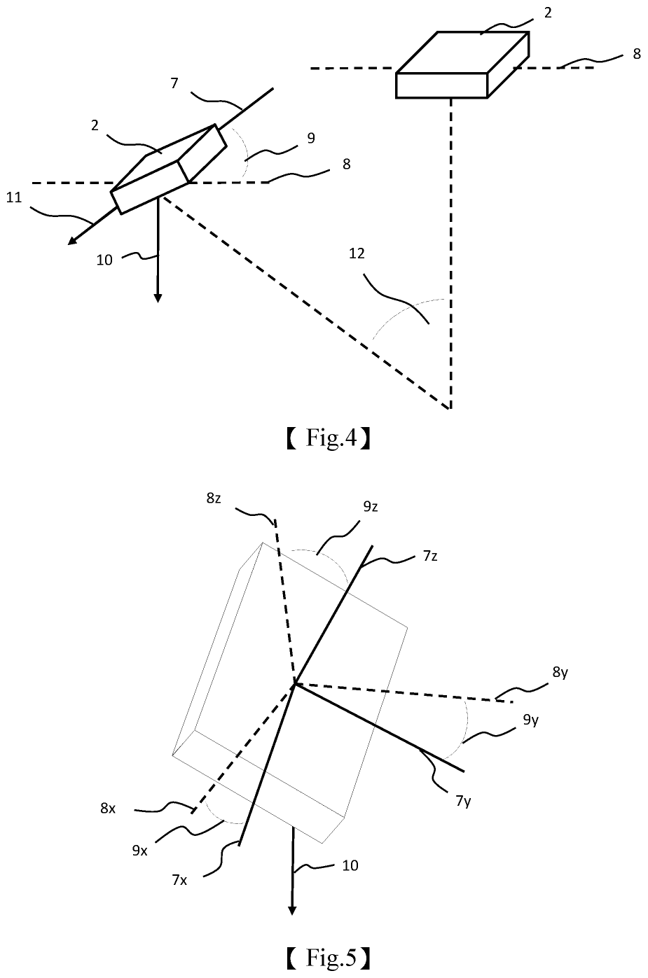

Please refer to FIG. 4, which is the schematic view of rotating the target point device in accordance with the present invention. As shown in FIG. 4, when the target point device 2 rotates counterclockwise by a target point rotational angle 12 to form a target point inclination angle 9 between one axial direction 7 and the original axial direction 8, the target point device can measure an axial-direction target point acceleration 11 in the axial direction 7 of the target point device 2.

The inclination angle converting unit 321 can obtain the target point inclination angle 9 of the axial direction 7 via the acceleration calculation equation for inclined plane. The acceleration calculation equation for inclined plane can be expressed as the equation given below:

$${θ}_{a x i s} = {sin}^{- 1} ( \frac{{A}_{a x i s}}{{g}_{0}} ) ;$$

In the above equation, g₀ stands for the standard gravity 10; θₐₓᵢₛ stands for the target point inclination angle 9 in the axis direction 7; Aₐₓᵢₛ stands for the target point acceleration 11 in the axial direction 7.

Then, the rotational angle converting unit 324 can estimate the target point inclination angle 9 is equal to the target point rotational angle 12 according to the relation of the original horizontal axis 8 being vertical to the direction of the standard gravity 10. Thus, the target point rotational angle 12 can be obtained accordingly.

Please refer to FIG. 5, which is the schematic view of rotating the target point device in multiple axes in accordance with the present invention. As shown in FIG. 5, the target point device 2 rotates in multiple axial directions. Accordingly, an x-axis target point inclination angle 9x is formed between the x-axis direction 7x and the original x-axis direction 8x, a y-axis target point inclination angle 9y is formed between the y-axis direction 7y and the original y-axis direction 8y, and a z-axis target point inclination angle 9z is formed between the z-axis direction 7z and the original z-axis direction 8z.

The rotational angle converting unit 324 can obtain the x-axis target point inclination angle 9x, the y-axis target point inclination angle 9y and the z-axis target point inclination angle 9z via the acceleration calculation equation for inclined plane. Then, the rotational angle converting unit 324 can obtain the target point rotational angle 12 of each of the axial directions according to the geometric relation of the target point inclination angle 9 being equal to the target point rotational angle 12. The acceleration calculation equation for inclined plane can be expressed as the equation given below:

$${θ}_{a x i s} = {sin}^{- 1} ( \frac{{A}_{a x i s}}{{g}_{0}} ) ;$$

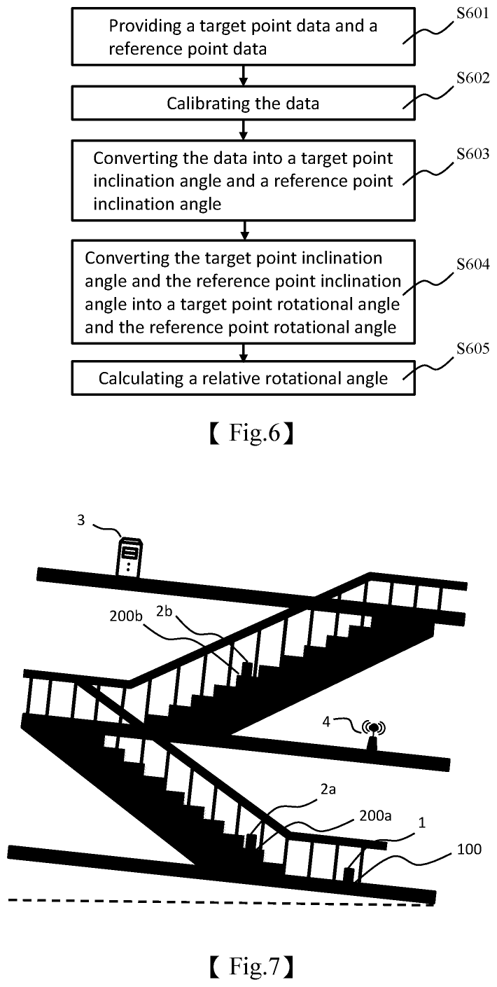

Please refer to FIG. 6, which is the flow chart of a relative rotational angle calculation method in accordance with the present invention. The relative rotational angle calculation method according to the present invention includes the following steps:
Step S601: providing a reference point data and a target point data.
Step S602: calibrating the reference point data and the target point data.
Step S603: converting the target point data into a target point inclination angle and converting the reference point data into a reference point inclination angle via an acceleration calculation equation for inclined plane.
Step S604: converting the reference point inclination angle into an x-axis reference point rotational angle, y-axis reference point rotational angle and z-axis reference point rotational angle, and converting the target point inclination angle into an x-axis target point rotational angle, y-axis target point rotational angle and z-axis target point rotational angle
Step S605: subtracting the x-axis reference point rotational angle from the x-axis target point rotational angle to obtain an x-axis relative inclination angle, subtracting the y-axis reference point rotational angle from the y-axis target point rotational angle to obtain a y-axis relative inclination angle, and subtracting the z-axis reference point rotational angle from the z-axis target point rotational angle to obtain a z-axis relative inclination angle.

Please refer to FIG. 7, which is the schematic view of a first embodiment of the present invention. As shown in FIG. 7, a house built along a hillside or having special indoor design may have slope stairways and the base of the stairway on the first floor is not parallel to the horizontal plane. The user can use the angle calculation system of the present invention and take the base of the stairway on the first floor as a reference point 100. Then, the user can put the reference point device at the reference point 100, put the first target point device 2a at the first target point 200a, and put the second target point device 2b at the second target point 200b. Next, the central communication device 4 can collect the reference point data 101 measured by the reference point device 1, and the target point data measured by the first target point device 2a and the second target point device 2b. Afterward, the central communication device 4 can transmit the above data to the terminal device 3.

After the above data are analyzed by the inclination angle converting unit and the horizontal angle converting unit, the terminal device 4 can obtain a reference point horizontal angle, a first target point horizontal angle and a second target point horizontal angle. Then, the relative horizontal angle calculating unit can calculate a first relative horizontal angle between the reference point 100 and the first target point 200a, and a second relative horizontal angle between the reference point 100 and the second target point 200b. The above calculations are as follows:

$$First relative horizontal angle = first target point horizontal angle - reference point horizontal angle .$$

$$Second relative horizontal angle = second target point horizontal angle - reference point horizontal angle .$$

Architects and civil engineers can adjust the stairways or measure the deformations of other construction items according to the first relative horizontal angle and the second relative horizontal angle.

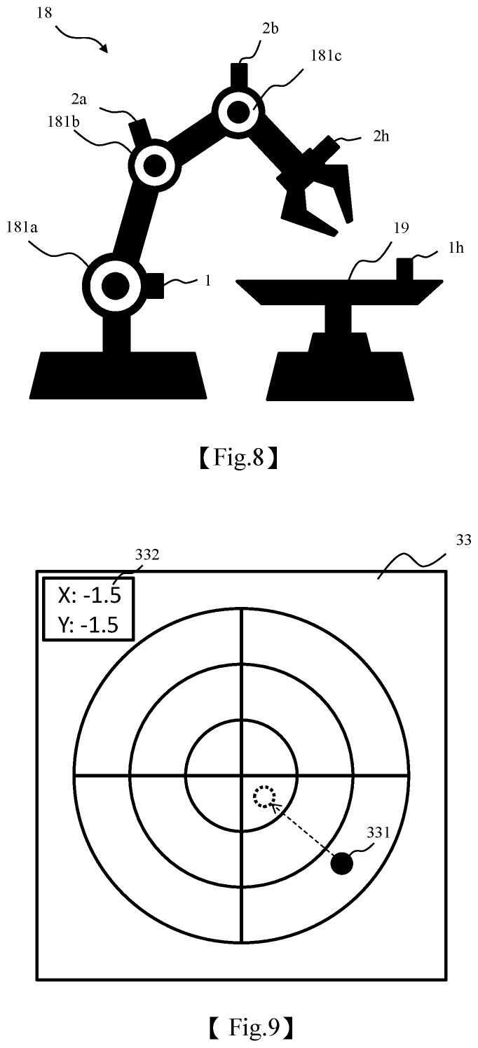

Please refer to FIG. 8, which is the schematic view of a second embodiment of the present invention. As shown in FIG. 8, the angle calculation system according to the present invention is applicable to the application of estimating the yield rate of a robotic arm 18. The robotic arm 18 has three rotational shafts 181, including a first rotational shaft 181a, a second rotational shaft 181b and a third rotational shaft 181c. The reference point device 1 is disposed on the first rotational shaft 181a, the first target point device 2a is disposed at the second rotational shaft 181b and the second target point device 2b is disposed on the third rotational shaft 181c.

In the second embodiment, when the first rotational shaft 18a rotates, the second rotational shaft 18b and the third rotational shaft 18c also rotate. Meanwhile, the reference point device 1, the first target point device 2a, the second target point device 2b on the rotational shafts 18 and a third target point device 2c on the target table 19 can generate the reference point data and the target point data due to inertia. Then, the reference point data and the target point data are transmitted to the terminal device 3. Afterward, the reference point data and the target point data are transmitted to the terminal device 4 so as to calculate the relative rotational angle between the target point rotational angle and the reference point rotational angle of each axial direction of the second rotational shaft 18b, the relative rotational angle between the target point rotational angle and the reference point rotational angle of each axial direction of the third rotational shaft 18c, and the relative horizontal angle between the target table 19 and the gripper 182.

Via analyzing the relative rotational angle of the second rotational shaft 18b and the relative rotational angle of the third rotational shaft 18c, the quality control personnel for estimating the yield rate of the robotic arm 18 can understand the errors of the rotational angles between the rotational shafts 181 so as to adjust the structure of the robotic arm 18.

Moreover, the angel calculation system of the present invention can be also applied to the real-time horizontal level test for a bridge. For instance, the reference point device and the target point device are disposed at the two ends of the bridge respectively with a view to keep monitoring the relative horizontal angle between the two ends of the bridge. In this way, the engineer can early know the bridge's damage due to typhoons or other disasters in order to prevent the damage of the bridge from deteriorating.

On the other hand, a horizontal reference point device 1h can be disposed on the gripper 182 and a horizontal target point device 2h can be disposed on the target table 19 so as to measure the horizontal relation between the gripper 182 of the robotic arm 18 and the target point device 19.

The present invention can be also applied to the semiconductor manufacturing industry. When the wafers are transported between the machines, the equipment engineer can put the reference point device on the target machine and put the target point device on the gripper of the end effector in order to avoid that the wafers are damaged, because of horizontal errors, during the transportation process.

Please refer to FIG. 9, which is the schematic view of a display module in accordance with the present invention. As shown in FIG. 9, the display module 33 of the present invention can present the relative horizontal angles and the relative rotational angles of the axes via a radar chart for the user. Then, the user can move with the radar point 331, and know the relative horizontal angles and the relative rotational angles according to the change of the coordinate table 332.

Besides, according to the present invention, the target point devices and the reference point device may be accelerometers, gyroscopes or the combination thereof.

In addition, according to the present invention, the central communication device may be a wireless access point.

Further, according to the present invention, the central communication device may be omitted. The terminal device can be directly connected to the target point device and the reference point device via the receiving unit.

To sum up, the present invention can integrate the target point devices, the reference point device and the processing module with each other to execute the angle calculation method with an eye to achieve the purpose of measuring the horizontal angles and the rotational angles of two points away from each other. Furthermore, the target point devices and the reference point device are small and light; the sizes of these devices are close to that of a cooper coin. Therefore, engineers can conveniently carry these devices. For the same reason, these devices can be installed on a target to be tested for a long time without causing the burden of the target to be tested so as to achieve the purpose of monitoring, in real time, the horizontal angles and the rotational angles of the target to be tested.

The above disclosure is related to the detailed technical contents and inventive features thereof. Those skilled in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

1. An angle calculating system, comprising:
a target point device configured to measure an inertia of a target point to obtain a target point data;
a reference point device configured to detect an inertia of a reference point to obtain a reference point data; and
a terminal device, comprising:
a receiving unit configured to receive the reference point data and the target point data; and
a processing module connected to the receiving unit, wherein the processing module comprises an inclination angle converting unit configured to convert the target point data into a target point inclination angle of the target point and convert the reference point data into a reference point inclination angle of the reference point;
wherein the target point data includes acceleration signals of the target point in axial directions, and the reference point data comprises acceleration signals of the reference point in the axial directions.

2. The angle calculating system of claim 1, further comprises:
a horizontal angle converting unit configured to convert the target point inclination angle into a target point horizontal angle and convert the reference point inclination angle into a reference point horizontal angle; and
a relative horizontal angle calculating unit configured to calculate a difference between the reference point inclination angle and the target point inclination angle in order to obtain a relative horizontal angle between the target point and the reference point.

3. The angle calculating system of claim 1, wherein the processing module further comprises:
a rotational angle converting unit configured to convert the target point inclination angle into the target point rotational angle and convert the reference point inclination angle into a reference point rotational angle′
a relative rotational angle calculating unit configured to calculate a difference between the target point rotational angle and the reference point rotational angle so as to obtain a relative rotational angle between the target point and the reference point.

4. The angle calculating system of claim 1, further comprising a central communication device connected to the target point device, the reference point device and the terminal device, wherein the central communication device is configured to receive the target point and the reference point data, and transmit the target point and the reference point data to the terminal device.

5. The angle calculating system of claim 2, further comprising a central communication device connected to the target point device, the reference point device and the terminal device, wherein the central communication device is configured to receive the target point and the reference point data, and transmit the target point and the reference point data to the terminal device.

6. The angle calculating system of claim 1, wherein the target point device or the reference point device is an accelerometer or a gyroscope or a combination thereof.

7. An angle calculating method, comprising:
providing a target point device comprising target point accelerations of a target point in axial directions;
providing a reference point device comprising reference point accelerations of a reference point in the axial directions;
converting the target point acceleration in each of the axial directions into a target point inclination angle of the target point in the corresponding axial direction according to an acceleration calculation equation for inclined plane and a standard gravity; and
converting the reference point acceleration in each of the axial directions into a reference point inclination angle of the reference point in the corresponding axial direction according to the acceleration calculation equation for inclined plane and the standard gravity.

8. The angle calculating method of claim 7, wherein the acceleration calculation equation for inclined plane is:
$${θ}_{axis} = {sin}^{- 1} ( \frac{{A}_{a x i s}}{{g}_{0}} ) ;$$
wherein g₀ stands for the standard gravity;
wherein θₐₓᵢₛ stands for the target point inclination angle or the reference point inclination angle in each of the axial directions;
wherein Aₐₓᵢₛ stands for the target point acceleration or the reference point acceleration in each of the axial directions.

9. The angle calculating method of claim 7, further comprising:
providing a standard data comprising a standard acceleration of a plurality of axes on a standard horizontal plane;
generating a calibration operator according to an error between the standard acceleration and the standard gravity; and
applying the calibration operator to the target point data and the reference point data;
wherein after the standard data is processed by the calibration operator, a sum of the standard accelerations of the axial directions is equal to the standard gravity.

10. The angle calculating method of claim 7, further comprising:
obtaining a target point horizontal angle of the target point in each of the axial directions according to a relation of the target point inclination angle in the axial direction being equal to the target point horizontal angle in the axial direction;
obtaining a reference point horizontal angle of the reference point in each of the axial directions according to a relation of the reference point inclination angle in the axial direction being equal to the reference point horizontal angle in the axial direction; and
calculating a difference between the reference point horizontal angle and the target point horizontal angle in order to obtain a relative horizontal angle between the target point and the reference point.

11. The angle calculating method of claim 7, further comprising:
obtaining a target point rotational angle of the target point in each of the axial directions according to a relation of the target point inclination angle in the axial direction being equal to the target point rotational angle in the axial direction;
obtaining a reference point rotational angle of the reference point in each of the axial directions according to a relation of the reference point inclination angle in the axial direction being equal to the reference point rotational angle in the axial direction; and
calculating a difference between the reference point rotational angle and the target point rotational angle in each of the axial directions in order to obtain a relative rotational angle between the target point and the reference point in the axial direction.
